(19) United States
(12) Patent Application Publication
(10) Pub. No.: US 2002/0124926 A1
(43) Pub. Date: Sep. 12, 2002

(54) Pneumatic rotary wheel coupling with early wheel bearing wear warning

(76) Inventors: Rafael A. Colussi, Guadalupe Norte (AR); Nestor J. Venica, Guadalupe Norte (AR)

Correspondence Address: Davidson, Davidson & Kappel, LLC, 485 Seventh Avenue, New York, NY, 10018, US

(21) Appl. No.: 09/804,378

(22) Filed: Mar. 12, 2001

(51) Int. Cl. B60C 23/10

(52) U.S. Cl. 152/417

(57) ABSTRACT

A pneumatic rotary coupling (25) for an air pressure installation for one or more wheels of a vehicle. The coupling's tube (49) has one end formed in the shape of a nozzle which extends in the plane of the wheel, disposed as an axial extension of the wheel's axle end. The tube is located rotary and slidable inside block (35) that is fixed to the wheel's hub cover. A cover (37) fixed to the block presents a chamber (45) with an edge that defines a seat for a plastic bushing (47) that supports the coupling's tube. The external surface of this bushing is conformed by grooves (53) that communicate the chamber towards the orifices linking with the tires. The coupling includes a valve (75) that is pushed open by the tube in the event of outward wheel offset, thereby depressurizing the chamber. The tube further includes grooves (87) for bypassing a seal (57) in the event of inward wheel offset, thereby depressurizing the chamber through a vent opening (65). In either case, the chamber depressurization signals the fault to the driver. The vent opening is in a circumferential recess (71) for housing an o-ring (73) that prevents dust, dirt and other undesirable particles from entering the coupling and the wheel bearings.

### FIELD OF THE INVENTION

The present invention relates to rotary couplings for mounting on wheels of a vehicle, to communicate the pressurized air of the tires with a pneumatic system installed onboard the vehicle, to track and control the pressure of the tires, compensating eventually for slight leaks by supplying air from a compressed air source, typically a compressor system in a bus or lorry or a pressurized air reservoir in a trailer. These couplings provide the pneumatically sealed connection between the installation considered as static and the rotary part, which as well can be affected by other relative movements such as vibrations.

The present invention also concerns early indication of wear in wheel bearings by means of air-leak valves provided in the couplings to prevent catastrophic failure of the wheel mounting at the end of the vehicle's axle.

### BRIEF DESCRIPTION OF THE PRIOR ART

In large and medium-sized vehicles, either passenger or cargo, it is of particular importance to control the pressure of the tires whilst on the road, due to the serious consequences an accident, caused by a flat tire, may bring upon when traveling at high speed and/or when other vehicles are on the road. For some years now it is standard to install pneumatic control and pressure compensating systems in these vehicles, that make use of the onboard compressor of the brake system to correct deficiencies detected in the air pressure of the tires. To this purpose, the referred system includes air piping passing through the hollow axle and connected via a rotary coupling to the tire intake valves. U.S. Pat. Nos. 5,584,949 and 6,105,645 to Anthony Ingram and 6,145,559 to Rupert Ingram disclose possible rotary coupling constructions. However, these systems are prone to air leaks that build up excessive pressure on the wheel's bearing mountings at the end of the vehicle's axle. This excessive pressure deteriorates the bearing seals and pushes the lubricant grease out of them, diminishing its useful life. This situation worsens when the rotary coupling's seals are worn out, which is generally detected only after some time when the leakage is of certain magnitude, forcing the vehicle's bearings to run dry and eventually break down.

Our U.S. patent application Ser. No. 09/497,249, the disclosure of which is hereby incorporated by reference, discloses a pneumatic rotary coupling enabling wear of bearings to be diagnosed by detecting a shift in the bearings position, due to wear, breakage or fault of one of its components, enough to produce wheel misalignments and de-centering relative to its axle, increasing the tire's wear and the fuel consumption and loss of lubrication in the wheel's bearings, not to mention the serious risk of the vehicle losing its axle end which is a high potential danger to other cars on the road.

The coupling of the referred '249 application comprises a body that is mounted to the wheel and inside of which a pressurized air chamber is formed, linked through one or more orifices in the body with the wheel's tubing. The body holds a rotary tube traversed axially by a conduit that leads into a chamber and a rotary seal to avoid, under normal functional conditions, pressurized air from leaking from the chamber through the interstitial gap between the tube and the body. The coupling's tube has an end that projects from the body to the wheel's plane provided with a connecting device to an air passage that runs inside the vehicle's axle to communicate the tire through the conduit with the air pressure control device. The coupling further comprises a vent orifice to depressurize the side of the seal opposite to the chamber, to protect the wheel's bearings. The coupling's tube is mounted with some axial play inside said body, enough to displace the end that leads into the chamber at the other side of the seal, thereby enabling monitoring a shift or misalignment of certain magnitude of the wheel's bearings, due to wear or breakage, by detection on a panel of the controlling device of a pressurized air leakage provided by the pipe to the coupling by means of the vent orifice.

### SUMMARY OF THE INVENTION

An object of the invention is a pneumatic coupling for one or more wheels located on the vehicle's axle end enabling detection of certain faults of some magnitude in the wheel's bearings by means of the same rotary coupling.

Another object of the invention is to monitor wheel displacements both inwardly and outwardly of the wheel axle.

Another object of the invention is to improve sensibility of the wheel bearing wear warning feature, such as by leaking pressurized air to signal wheel displacements as little as 1 mm.

Another object of the invention is to improve protection of the wheel's bearings from exposure to excessive air-pressures coming from the coupling.

Another object of the invention is to increase airflow through a vent opening to relieve wheel bearings and related structure from excessive air-pressure.

To attain these and other objects and advantages, the rotary coupling of the present invention is provided with a normally closed spring valve adapted to be opened by an outward shift of the axial tube passing air from inside the vehicle axle. In addition, the tube may include a groove on the outer tube surface a short axial distance outwardly of the primary seal, in order to increase flow of air purposely leaking past the seal in the event of an inward shift of the tube. Furthermore, the vent opening opens out to the exterior of the coupling body at a circumferential recess formed in the body to retain an o-ring normally closing the vent opening to avoid entry of dirt, dust and other particles having an undesirable effect on bearings and seals.

### BRIEF DESCRIPTION OF THE DRAWINGS

These and other characteristics and details of the object of this invention and the manner it can be developed, implemented and put into practice may be better understood with the following detailed description of an example embodiment illustrated in the attached drawings, in which:

FIG. 1 is a schematic, cross-section view of a vehicle axle end whereon a rotary coupling according to a preferred embodiment of the present invention is mounted.

FIG. 2 is a cross-section view of the rotary coupling according to the lo embodiment of the FIG. 1.

FIG. 3 is a partial, magnified view of the vent opening of the rotary coupling the FIG. 2 showing an o-ring normally sealing the opening.

### PREFERRED EMBODIMENT OF THE INVENTION

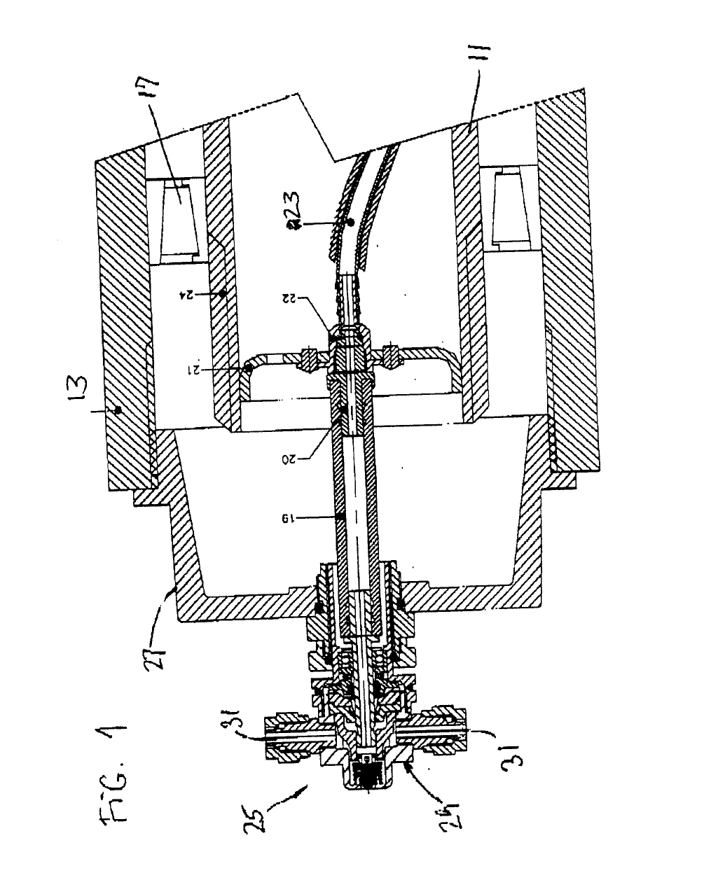

In FIG. 1, the end of axle 11 of a motor vehicle, such as in a truck, a trailer or a large bus, is shown. A wheel's hub 13 for mounting a single or double tire is mounted on the end of axle 11 by means of bearings 17.

The pressurized air pipe 21 enters the hollow axle 11 and extends towards the end where the wheel is mounted, where a flexible rubber and cloth pipe section 23 connects it axially to the rotary coupling 25 of the present invention, which is mounted on the wheel's hub cover 27 that protects the bearings 17. In FIG. 1, the body 29 of the coupling 25 can be seen. Two orifices 31 are shown for connecting the coupling 25 by means of the respective hose sections to the nozzles of the pair of tires. The coupling 25 provides continuous sealed communication between the pipe 21 and the tires, thereby bridging the relative movement between the tires due to the wheel's rotation. The pair of orifices 31 are placed radially opposite each other for a better dynamic balance of the wheels.

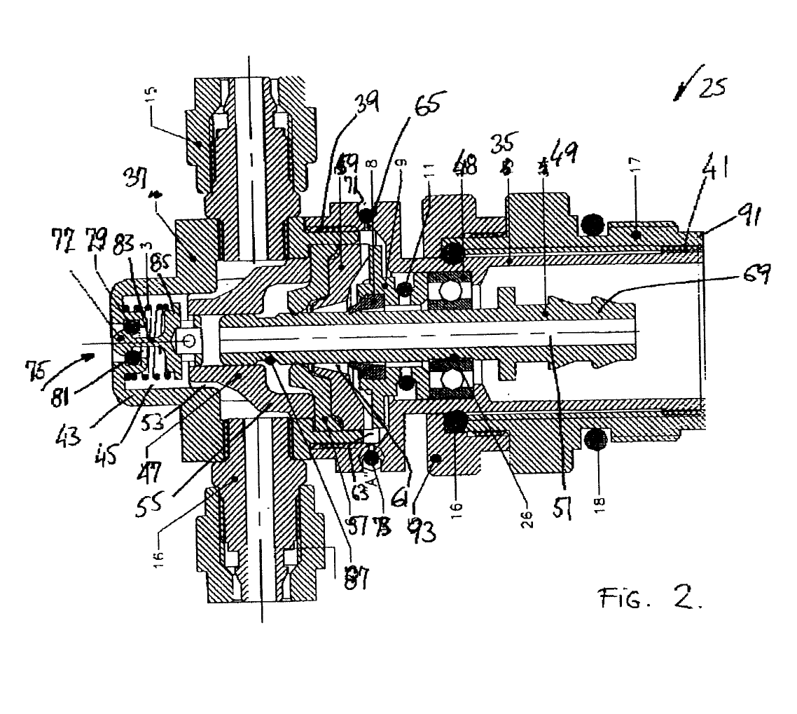

FIG. 2 details a preferred construction of the coupling 25. The coupling 25 consists of a body formed by a block 35 and a cover 37 fixed to the block 35 by means of a thread 39. The block 35 is formed with a second external thread 41 for attaching to the wheel's hub cover 27. The cover 37 contains the orifices 31 which communicate to the tire(s). The cover 37 comprises as well a cup shaped portion 43 the interior of which defines the chamber 45 and the cup edge forming a seat for a plastic bushing 47 for the rotary mounting of a tube 49. The tube 49 is held in axial position by the bushing 47 and by ball-bearings 48 such that it may rotate and shift axially (i.e., longitudinally) with corresponding wheel movement relative to the axle.

The tube 49 is traversed longitudinally by a conduit 51, which leads to the chamber 45. The passage of air continues from this chamber 45 towards the orifices 31 by means of axial grooves 53 formed on the lateral surface of the bushing 47. The bushing 47 continues inwards with a skirt 55 that supports a seal 57 that bears against a plastic washer 59. The seal 57 is preferably double lipped to resist the full tire air pressure.

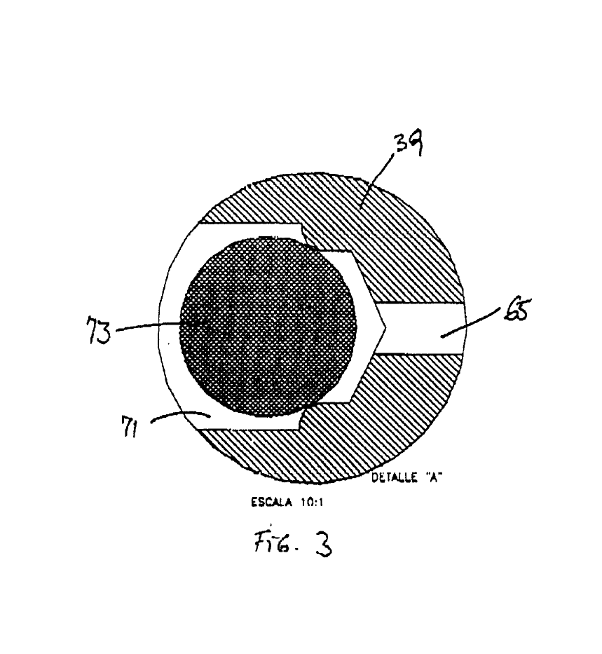

The washer 59 has radial grooves 61 that communicate any air excess pressure that reaches the seal 57 to a gap 63 from where it can be vented through an opening 65. The vent 65 opens outwardly at a circumferential recess 71 formed in the external surface of the block 35. The recess has a step shape as shown in FIG. 3, seating an o-ring 73 that normally closes the vent opening 65.

The inner end of tube 49 of the coupling 25 includes teeth 69 for axial connection to pipe sections 23. This flexible connection allows for eccentricity tolerances and axial misalignments in the mounting of coupling 25 relative to the wheel's axle 11.

The cup-shaped portion 43 of the cover 37 has a recess axially aligned with the tube 49 and housing a valve 75 for depressurizing the chamber 45 in certain circumstances as described hereafter. The valve 75 comprises a generally ball-shaped valve element 77 normally seated on a seal 79 surrounding an orifice 81 centered in the recess 71. The valve element 77 is connected by a stem 83 passing through orifice 81 to a disk-shaped foot 85 located inside the chamber 45. The foot 85 is positioned at a short distance, say 2 mm, facing the outer end of the tube 49 in the chamber 45. A spring 86 is pressed between the cup-shaped portion 43 and the foot 85 to urge the valve 75 to a normally sealed position. In this manner, in the event that the tube 49 is shifted outwardly that short axial distance, it will push on foot 85 to open the valve 75, thereby depressurizing the chamber 45 to signal a corresponding axial offset of the wheel.

The outer surface of the tube 49 is formed with one or more grooves 87 a short axial distance, say 2 mm, outwardly of the lip of seal 57, to bypass air pressure from the chamber 45 to the vent 65 across the seal 57 in the event that the tube is shifted inwardly approximately said short axial distance, to signal worn wheel bearings or another fault causing axial offset of the wheel. Instead of a number of spaced grooves 87, the outer surface of the tube may be formed with a circumferential groove 87.

It can therefore be seen that in view of that the tube 49 is mounted so it can shift axially inside body 35-37, it allows for the detection of wearing or loose elements of the wheel. The block 35 is fixed to the wheel centre's cover by means of the thread 41. This thread 41 is relative extensive and is made to continue through a tubular extension 91 to receive also a counternut 93 to calibrate the axial position of tube 49 so that its end fits into bushing 47. In the event of excessive play in the wheel, the pressurized air in the chamber 45 will be vented either through the opening 65 or the valve 75 to the outside, thereby warning the driver to check whether a tire could be punctured or bearing worn.

Various modifications, variations and/or additions can be made to the embodiment described herein, within the scope and spirit of the invention.

We claim:

1.- A rotary coupling for one or more wheels mounted to an axle end of a vehicle, for communicating at least one wheel tire to an air-pressure control arrangement installed on the vehicle and comprising:
a body mounted communication to the wheel and having at least one orifice formed therein for with said at least one tire;
a pressurized air chamber formed inside said body in communication with said at least one orifice;
a rotary tube mounted axially slidable inside said body tube and having opposite inner and outer ends, said tube axially traversed by a conduit extending between said inner and outer ends, said outer end normally projecting into said chamber and said inner end projecting from said body and provided with a connection device to a pressurized air passage passing inside said vehicle axle for operatively communicating said chamber through said conduit to said air-pressure control system; and
a spring valve providing a normally closed passage through said body from said chamber, wherein said outer tube end is arranged to push said spring valve open in response to predetermined sliding motion of said tube relative to said body.

2.- A rotary pneumatic coupling according to claim 1, wherein said spring valve comprises:
a valve orifice passing through said body coaxially to said tube,
a valve seat surrounding said orifice,
a valve element including a stem extending inwardly from said valve element and terminating in a foot normally placed a short axial distance from said outer tube end, and
spring means urging said valve element into sealing engagement with said valve seat;
whereby upon axial outward movement of said tube, said outer end of said tube pushes against said foot to open said valve and vent air from said chamber.

3.- A rotary pneumatic coupling according to claim 2, wherein said body has a recess containing said orifice and valve seat such that said valve element substantially does not protrude from said body.

4.- A rotary pneumatic coupling according to claim 1, and further comprising: a rotary seal housed in said body and mounted about said rotary coupling tube to normally block pressurized air from leaking from said chamber, a vent opening on the opposite side of said seal from said chamber, and means for preventing dirt, dust and particles from entering said vent opening into said body.

5.- A rotary pneumatic coupling according to claim 1, wherein the outer end of said coupling tube is supported by a plastics bushing seated on said body and wherein said bushing is shaped with at least one passage communicating said chamber to said at least one orifice.

6.- A rotary pneumatic coupling according to claim 5, wherein said at least one passage comprises grooves formed on the external surface of said bushing.

7.- A rotary pneumatic coupling according to claim 5, wherein said bushing comprises a circumferential skirt supporting a primary seal bearing against a washer, said washer including radial grooves opening out to a gap defined between the side of said washer opposite to said seal and a secondary seal arranged between said body and said coupling tube, said gap opening towards said vent orifice.

8.- A rotary pneumatic coupling according to claim 7, wherein said body comprises a block housing said secondary seal and provided with means for attaching to said wheel and a cover affixed to said block and housing said bushing, said primary seal and said washer, wherein said gap is formed between said block and said cover.

9.- A rotary pneumatic coupling according to claim 8, wherein said cover has a cup-shaped portion with an edge defining a seat for said bushing and an inside defining said chamber.

10.- A rotary coupling for one or more wheels mounted to an axle end of a vehicle, for communicating at least one wheel tire to an air-pressure control arrangement installed on the vehicle and comprising:
a body mounted to the wheel and having at least one orifice formed therein for communication with said at least one tire,
a pressurized air chamber formed inside said body in communication with said at least one orifice,
a rotary tube mounted axially slidable inside said body tube and having opposite inner and outer ends, said tube axially traversed by a conduit extending between said inner and outer ends, said outer end normally projecting into said chamber and said inner end projecting from said body and provided with a connection device to a pressurized air passage passing inside said vehicle axle for operatively communicating said chamber through said conduit to said air-pressure control system;
a rotary seal housed in said body and mounted about said rotary coupling tube to normally block pressurized air from leaking from said chamber, and
a vent opening on the opposite side of said seal from said chamber; wherein said tube has a groove at a short predetermined axial distance from said seal, whereby said seal engages said groove in response to said tube sliding axially inwards relative to said body to leak air from said chamber to said vent opening via between said groove and said seal.

11.- A rotary pneumatic coupling according to claim 10, and further comprising means for preventing dirt, dust and particles from entering said vent opening into said body.

12.- A rotary pneumatic coupling according to claim 10, wherein said body has a circumferential recess at the axial height of said vent opening and said preventing means comprises an o-ring element in said recess and normally covering said vent opening, said o-ring element being displaceable by excess air pressure from within said body to open said vent opening.

13.- A rotary pneumatic coupling according to claim 10, wherein said tube inner end is formed as an axial connection device for connection to the end of the vehicle axle.

14.- A rotary pneumatic coupling according to claim 10, wherein the inner end of said coupling tube is supported by a plastics bushing seated on said body and wherein said bushing is shaped with at least one passage communicating said chamber to at least one orifice.

15.- A rotary pneumatic coupling according to claim 14, wherein said at least one passage comprises grooves formed on the external surface of said bushing.

16.- A rotary pneumatic coupling according to claim 14, wherein said bushing comprises a circumferential skirt supporting a primary seal bearing against a washer.

17.- A rotary pneumatic coupling according to claim 16, wherein said washer includes radial grooves opening out to a gap defined between the side of said washer opposite to said seal and a secondary seal arranged between said body and said coupling tube, said gap opening towards said vent opening.

18.- A rotary pneumatic coupling according to claim 17, wherein said body comprises a block housing said secondary seal and provided with means for attaching to said wheel and a cover affixed to said block and housing said bushing, said primary seal and said washer, with said gap defined between said block and said cover.

19.- A rotary pneumatic coupling according to claim 18, wherein said cover has a cup-shaped portion with an edge defining a seat for said bushing and an inside defining said chamber.

20.- A rotary pneumatic coupling according to claim 19, wherein said cup-shaped portion has a spring valve providing a normally closed passage through said body from said chamber, wherein said outer tube end is arranged to push said spring valve open in response to predetermined sliding motion of said tube relative to said body.

21.- A rotary pneumatic coupling according to claim 20, wherein said spring valve comprises:
a valve orifice passing through said body coaxially to said tube,
a valve seat surrounding said orifice,
a valve element including a stem extending inwardly from said valve element and terminating in a disk normally placed a short axial distance from said outer tube end, and
spring means urging said valve element into sealing engagement with said valve seat;
whereby upon axial outward movement of said tube, said outer end of said tube pushes against said disk to open said valve and vent air from said chamber.

22.- A rotary pneumatic coupling according to claim 21, wherein said cup-shaped portion has a recess containing said orifice and valve seat such that said valve element does not substantially protrude from said body.

23.- In an air pressure control system installed in a vehicle, for supplying air from a pressurized air source installed in a static part of the vehicle to one or more tires mounted inside rotary wheels of the vehicle, a rotary pneumatic coupling according to claim 1 mounted to the end of an axle mounting said at least one wheel for communicating air between the static part of the installation and said at least one tire.

24.- In an air pressure control system installed in a vehicle, for supplying air from a pressurized air source installed in a static part of the vehicle to one or more tires mounted inside rotary wheels of the vehicle, a rotary pneumatic coupling according to claim 10 mounted to the end of an axle mounting said at least one wheel for communicating air between the static part of the installation and said at least one tire.
